(19) United States
(12) Patent Application Publication
(10) Pub. No.: US 2002/0117086 A1
(43) Pub. Date: Aug. 29, 2002

(54) Low shrinkage, high strength cellular lightweight concrete

(76) Inventors: Caijun Shi, Burlington (CA); Yanzhong Wu, Hamilton (CA); Monte Riefler, Hamburg, NY (US)

Correspondence Address: Michael F. Scalise, Hodgson Russ LLP, Suite 2000, One M&T Plaza, Buffalo, NY, 14203-2391, US

(21) Appl. No.: 10/050,248

(22) Filed: Jan. 16, 2002

Related U.S. Application Data
(63) Continuation-in-part of application No. 09/740,464, filed on Dec. 19, 2000.

(51) Int. Cl. C04B 38/10

(52) U.S. Cl. 106/672

(57) ABSTRACT

An economical structural cellular lightweight concrete with a density of from about 45 lb/ft³ to about 90 lb/ft³ and a strength from about 1,000 psi to about 6,000 psi after 28 days of curing at room temperature and with minimal shrinkage on drying, is described. The concrete comprises cement, lightweight aggregate with a density from about 25 lb/ft³ to about 60 lb/ft³, fiber, superplastizer, gas and/or foaming agents, and a shrinkage reducing agent. The concrete can be manufactured using facilities for conventional concrete even with a portion of Portland cement replaced by industrial by-products or recycled materials such as blast furnace slag, coal fly ash and recycled glasses. The preferred procedure for making the lightweight concrete is also described. The products made with the lightweight concrete have much better ductility and construction capabilities than conventional concrete products.

### CROSS-REFERENCE TO RELATED APPLICATION

The present application is a continuation-in-part of application Ser. No. 09/740,464, filed Dec. 19, 2000, now abandoned.

### FIELD OF THE INVENTION

This invention relates to concrete compositions and method of use of such compositions to produce a fiber reinforced, low shrinkage high strength cellular lightweight concrete. The cellular lightweight concrete has a dry density from about 45 lb/ft³ to about 90 lb/ft³ with a strength from about 1,000 psi to about 6,000 psi after 28 days of room temperature curing, and is suitable for structural applications.

### BACKGROUND OF THE INVENTION

In general, there are two ways to achieve a low-density concrete. First, is to use a low-density aggregate such as pumice or other lightweight rock. The second way is to introduce gas or foam into the concrete mixture. A concrete with homogeneous void or cell structure is called cellular concrete.

Cellular concrete is known for its properties including thermal and sound insulation, as well as being a lightweight material. According to ASTM specifications, a cellular concrete is a lightweight product consisting of Portland cement, cement-silica, cement-pozzolan, lime-pozzolan, lime-silica pastes or pastes containing blends of these gradients and having homogeneous void or cell structures, attained with gas-forming chemicals of foaming agents.

Cellular lightweight concrete made with a gas-forming agent usually uses cement, lime and fly ash or ground silica as raw materials and is cured in an autoclave. A stabilizer is used to stabilize the gas bubbles generated from the chemical reactions between the gas-forming agent and water. Aggregates usually cannot be used since they damage the cellular structure formed in the concrete mixture as they settle.

When a foaming agent is used, it is first fed into a generator to generate foam, then mixed with a concrete mixture to form a cellular structure. Typically, a stabilizer is used. Aggregates cannot be used for the same reason they are not used with gas-forming agents. Foamed cellular lightweight concrete, usually cured under atmospheric pressure, has relatively low strength and is used mainly as an insulation material or flowable filler.

The main hydration product of autoclaved cellular lightweight concrete is crystallized calcium silicate hydrate, which is called tobermorite. This compound makes concrete products very stable. The main hydration product of foamed cellular concrete, using ambient environment curing at atmospheric pressure, is amorphous calcium silicate hydrate. This compound can result in excessive shrinkage and cracking, especially in the absence of aggregate.

U.S. Pat. No. 4,077,809 to Plunguian et al. discloses a foamed lightweight concrete composition comprised of mineral cement, a mineral aggregate, chopped fiber glass or glass fabric, a film-former and a viscosifer foam stabilizer, a foaming agent and a certain synthetic resin. Plunguian et al. use foam stabilizers to generate stable air voids in the concrete mixture. According to the “State-of-the-Art Report on Fiber Reinforced Concrete”, which is written by the technical committee 540—Fiber Reinforced Concrete of American Concrete Institute, when either fiber glass or alkali resistant glass fiber is included in concrete, they react with the cement alkalis and are eventually consumed, voiding their purpose in the concrete composition. Also, the concrete will have high shrinkage and may cracks during drying, and is only suitable for insulation not for structural applications.

U.S. Pat. No. 4,293,341 to Dudley et al discloses an insulating concrete using cement, foaming agent and lightweigh aggregate with a density less than 10 lb/f³.

U.S. Pat. No. 5,183,505 to Spinney discloses the use of bentonite as a foam stablizer to manufacture foamed concrete.

U.S. Pat. No. 5,250,578 to Cornwell discloses a composition the same as disclosed in the Plunquian et al. '809 patent, but for a different application.

U.S. Pat. No. 5,772,752 to Liskowitz et al. discloses an additive, such as coal fly ash, for closing or bridging air-voids on the surface of porous lightweight aggregate so a lighter and durable concrete is produced. This is essentially the same as lightweight aggregate concrete.

U.S. Pat. No. 4,351,670 to Grice discloses a low density, non-shrinking concrete, possessing high strength and favorable insulation properties. The concrete manufacturing process includes the steps of providing a body of cured cellular concrete, breaking the body into fragments, coating the cellular concrete fragments with a thin layer of cement which is allowed to cure, and incorporating the coated fragments into a cement matrix to form a low density concrete. The cellular concrete fragments are preferably tumbled to remove sharp corners prior to the coating operation. The tumbling and coating operations are preferably carried out on fragments that have been classified by size. The concrete in the ultimate mix avoids the shrinkage problems normally associated with cellular concrete and, therefore, is suitable for use in cast-in-place building slabs and precast panels or as core material in composite building elements. However, the breaking and coating of cellular concrete fragments is a complex and expensive process.

U.S. Pat. No. 5,002,620 to King discloses a method for a composite product formed by casting the lighter fraction over the heavier fraction to form a single sheet. The lighter fractions of separate sheets, which are planed and bonded together, have a vapor barrier between them to form blocks, wall panels, beams, and the like. This patent also discloses that the concrete may be comprised of materials selected from the group including: Portland cement, suitable aggregates, fibrous reinforcing materials, ash from refuse-derived fuel, expanded silicate, water, sand, a preferred foaming agent, and a source of compressed gas used in part to induce bubbles into the mix, and a suitable vapor barrier/resin for use in bonding and moisture resistance. However, this patent does not elicit information regarding these materials and proportions for each of them.

U.S. Pat. No. 5,397,316 to LaVon et al. discloses a process of molding a building panel including the steps of combining approximately 25 pounds of Type I Portland Cement, about 15 pounds of water at 21° C., adding about 1 ounce of aluminum, calcium, magnesium, and silica, respectively, and about 12 ounces of synthetic fibers with about 0.1 ounce of ferro chloride in a 40% by volume solution. This mixture is poured into a mold, filled to about 50% of its depth, and then allowed to set for approximately 4 hours so the mixture expands to about 100% of its original volume. Thereafter, the mold is stripped and the sample is placed in a heated environment to cure for a period of about 24 hours. This process exclusively uses Portland cement as the cementing component without any supplementary cementitious materials or aggregate. The panels manufactured by this process, after drying, show excessive shrinkage and cracking.

Use of lightweight aggregate for production of lightweight concrete is now commonly practiced. U.S. Pat. No. 4,086,098 to Le Ruyet discloses a cellular aggregate distributed in a hardenable or hardened binder or matrix material. This is virtually a lightweight aggregate concrete.

U.S. Pat. No. 5,494,513 to Fu et al. discloses a lightweight concrete that uses porous zeolite as both cement replacement and aggregate. This is a lightweight concrete composition, or product, comprising 40-100 wt % cementing material and 0-60 wt % aggregate, and having a dry bulk density of 300-1600 kg/m³. The concrete composition has a compressive strength of 0.3-35 MPa after 3-6 hours autoclave curing at 170-180° C., or after 8-14 hours moist-curing at 75-85° C., or after 28 days moist-curing at 23° C. The cementing material comprises about 50-80 wt % of zeolite, which is either non-calcined or calcined above 800° C., about 20-49 wt % Portland cement and about 1-8 wt % strengthening agent. While zeolite is widely used in many industries for more sophisticated applications, it is too expensive to be used as a replacement for cement or concrete aggregate.

Hardened concrete shrinks during drying, which can cause cracking of the concrete. Cellular lightweight concrete shows much larger drying Shrinkage than regular concrete. The literature teaches that various oxyalkylene adducts are suitable for the reduction of drying shrinkage of concrete. For example, U.S. Pat. Nos. 3,663,251 and 4,547,223 suggest the use of compounds of the general formula RO(AO)ₙH in which R may be a C₁₋₇ alkyl or C₅₋₆ cycloalkyl radical, A may be C₂₋₃ alkylene radicals and n is 1-10 as shrinkage reducing additives for cement. Similarly, U.S. Pat. No. 5,147,820 suggests that terminally alkyletherified or alkylesterified oxyalkylene polymers are useful for shrinkage reduction. U.S. Pat. No. 6,251,180 teaches the use of additives comprising at least one cyclic acetal of a tri or polyhydric alcohol.

While oxyalkylene compounds provide a degree of shrinkage inhibition to cement paste or concrete, they have been known to have negative effects on air voids in fresh concrete mixtures, thereby, causing such concrete mixtures to have an undesirably low degree of air entrainment. For example, U.S. Pat. No. 3,663,251 shows, by comparative examples, that the inclusion of a polypropylene glycol reduces the air entrainment of a mixture containing an agent composed of sulfite waste liquor. Further, Canadian Patent 967,321 suggests that polyoxyalkylene glycols as well as their esters, ethers and mixtures reduce foaming in concrete. Thus, conventional shrinkage reducing agents cannot be used in cellular lightweight concrete.

Lightweight concrete is becoming more and more universally accepted because of its low density and excellent insulation properties. Usually, structural lightweight concrete under production conditions has a strength from 3,000 to 6,000 psi and a dry density in excess of 110 lb/ft³. Cellular lightweight concrete cured under autoclave usually weighs less than 45 lb/ft³, with a strength lower than 1,000 psi. Although autoclave production can produce dimensionally stable products, it requires complicated, high maintenance equipment and large capital investment. Also, traditional autoclaved cellular lightweight concrete without fiber reinforcement is very fragile and can be easily damaged during handling, transportation and construction. Cellular lightweight concrete produced at room temperatures usually has a low density, with very low strength and very high shrinkage. It cannot be used as structural concrete. Instead, it is typically used as an insulation material or as a flowable fill in geotechnical applications.

Therefore, there still exists a need for a cellular lightweight concrete which has a low density and low shrinkage, but is strong enough for structural applications and can be readily manufactured at low cost.

### BRIEF DESCRIPTION OF THE DRAWINGS

FIG. 1 is a graph illustrating the effect of the addition of aggregate to control shrinkage of lightweight cellular concrete containing fly ash.

FIG. 2 is a graph illustrating the effect of the addition of aggregate to weight loss of lightweight cellular concrete containing fly ash.

FIG. 3 is a graph illustrating the effect of the addition of aggregate to control shrinkage of lightweight cellular concrete containing ground glass.

FIG. 4 is a graph illustrating the effect of the addition of shrinkage reducing agent and aggregate to control shrinkage of cellular lightweight concrete containing ground glass.

FIG. 5 is a photograph showing the lifting of a 4′×4′×6′ concrete tank with a thickness of 4″ made with Mix 10 after approximately 6 hours of steam curing at about 65° C.

FIG. 6 is a photograph showing the direct lifting of a 10′×10′×3″ concrete panel after approximately 6 hours of steam curing at about 65° C.

FIG. 7 is a comparative photograph of an air entrainment test of a cement mixture without polypropylene fiber and with the fiber, respectively.

### SUMMARY OF THE INVENTION

According to the present invention, a cellular lightweight concrete having low shrinkage and high strength with a dry density of from about 45 lb/ft³ to about 90 lb/ft³ and a strength of from about 1,000 psi to 6,000 psi after 28 days of room temperature curing is produced. The cellular lightweight concrete is made by mixing cement, fiber, a specific lightweight aggregate, a gas-forming or foaming agent and a shrinkage reducing agent in a conventional concrete mixer. The use of fiber ensures the stability of the cellular structure and the aggregate in the concrete mixture slurry, and increases the flexural strength, plasticity and impact resistance of hardened concrete. Using a proper lightweight aggregate decreases shrinkage significantly and eliminates shrinkage cracking while reducing the density of the concrete as well. The use of a proper amount of aggregate also ensures the introduction of air bubbles into the concrete mixture when a foaming agent is directly added into a conventional concrete mixer. The shrinkage reducing agent used in this invention is comprised of a mixture of certain alkyl ether oxyalkylene adducts with certain oxyalkylene glycols, which can reduce drying shrinkage of cellular lightweight concrete while permitting a stable void structure with enhanced compressive strength.

More particularly, it is an object of this invention to provide a fiber-reinforced structural cellular lightweight concrete containing fiber, gas-forming or foaming agent, lightweight aggregate, and a shrinkage reducing agent.

A further objective of this invention is to produce structural cellular lightweight concrete mixtures made either with gas-forming or foaming agents using conventional concrete mixing equipment.

A further objective of this invention is to produce a fiber-reinforced structural cellular lightweight concrete cured at temperatures under atmospheric pressure, and which exhibits minimal shrinkage and cracking.

A further objective of this invention is to produce fiber-reinforced structural cellular lightweight concrete products having high flexural strength, plasticity and impact resistance, and exhibiting durability during handling, transportation, and construction.

A further objective of this invention is to provide a shrinkage reducing agent suitable for cellular lightweight concrete, which can reduce drying shrinkage of cellular lightweight concrete while providing a stable void structure with enhanced compressive strength.

Yet another objective of this invention is to provide a method for manufacturing a less expensive fiber-reinforced cellular lightweight concrete product using cement replacements and lightweight aggregate.

The aforementioned objectives are achieved by cellular lightweight concrete mixtures produced according to the present invention.

Briefly, therefore, the invention is directed to fiber-reinforced cellular lightweight concrete mixtures containing suitable aggregates which can be cured in steam at various temperatures, and which are characterized as having a dry density of from about 45 lb/ft³ to about 90 lb/ft³, and a strength from about 1,000 psi to about 6,000 psi after about 28 days of room temperature curing, while exhibiting relatively low shrinkage. The mixtures according to the present invention are composed of: about 30 wt % to about 45 wt % cementing material, 20 wt % to about 55 wt % aggregates, O to about 10 wt % lime, about 0.1 wt % to 5 wt % fiber, about 12 wt % to about 30 wt % water, about 0.01% to about 3 wt % of a shrinkage reducing agent, about 0.02% to about 1% of a superplasticizer, and about 0.001% to about 1 wt % of a gas-forming or foaming agent. These materials are mixed to form flowable mixtures, and poured into molds. The resulting products can either be cured at room or at elevated temperatures.

With the forgoing and other objects, features and advantages of the invention that will become hereinafter apparent, the nature of the invention may be more clearly understood by reference to the following detailed description of presently preferred embodiments of the invention and the appended claims given for the purpose of disclosure.

### DESCRIPTION OF THE PREFERRED EMBODIMENT

The invention includes a mixture for producing fiber-reinforced structural cellular lightweight concrete with a dry density of from about 45 lb/ft³ to about 90 lb/ft³ and a strength of from about 1,000 psi to about 6,000 psi after 28 days of room temperature curing. The mixture comprises a cementing material, lightweight aggregate, lime, fiber, a gas-forming or foaming agent, and water. The invention also describes a method of making fiber-reinforced cellular lightweight concrete including mixing these materials in a mixer to form a thick and viscous slurry which can be foamed and cured at room or elevated temperatures.

A concrete mix according to the invention comprises the following components, in approximate percents by weight:

| | |
|---|---|
| Cementing material | 30 to 45 |
| Lightweight Aggregate | 20 to 55 |
| Lime | 0 to 10 |
| Fiber | 0.02 to 5 |
| Superplastizer | 0.02 to 1 |
| Shrinkage Reducing Agent | 0.01 to 3 |
| Gas-forming or Foaming Agent | 0.001 to 1 |
| Water | 12 to 30 |

Cementing material is used as a binder for the concrete mix and is the primary structural material of the concrete. The amount of cementing material should be between about 30 wt % to about 45 wt % of the total mixture. If the content of the cementing material is lower than 30 wt %, there is not enough cement serving to glue the aggregate together and the workability of the mixture is very poor. If the cement content is higher than about 45 wt %, higher shrinkage and thermal expansion cracking can occur.

Fine powders, which can replace a portion of Portland cement, are divided into two categories: reactive and non-reactive. Reactive fine powders have cementitious or pozzolanic properties and serve as supplementary cementing materials. They include ground blast furnace slag, coal fly ash, natural pozzolans, ground steel slag and silica fume. Based on ASTM specification C11, cementitious materials refer to those that, when mixing with water, with or without aggregate, provide the plasticity and the cohesive and adhesive properties necessary for placement and formation of a rigid mass. Based on ASTM C618, pozzolanic materials refer to siliceous and aluminous materials which in themselves possess little or no cementitious value but will, in a finely divided form and in the presence of moisture, chemically react with calcium hydroxide at ambient temperatures to form compounds possessing cementitious properties.

According to ASTM C125, the term aggregates generally refers to granular material such as sand, gravel, crushed stone or iron blast furnace slag, used with cementing medium to form a hydraulic-cement concrete or mortar. Aggregate that has an oven-dry density of less than about 90 lb/ft³ and is used to produce lightweight concrete is called lightweight aggregate. Based on its origin, lightweight aggregate can be classified into natural and synthetic types. Synthetic lightweight aggregates include expanded, palletized or sintered blast furnace slag, clay, diatomite, fly ash, shale, perlite, vermiculite or slate; natural lightweight aggregates include volcanic ash, pumice, scoria and tuff.

Simply based on size, aggregate can be classified into fine and coarse. Fine aggregate refers to material passing a No. 4 sieve (4.75 mm), while coarse aggregate refers to material larger than 4.75 mm. In order to manufacture a lightweight concrete product according to the present invention, the aggregate should have an oven-dry density between about 25 lb/ft³ and about 60 lb/ft³. If the density of the aggregate is too low, it usually displays relatively low strength and will not be strong enough to manufacture concrete having a desired strength. On the other hand, if the density of the aggregate is too high, the density of the concrete will be too high. Also, a too dense aggregate will settle in the cellular concrete mixture and cause segregation.

Lime is needed to increase the alkalinity of the mixture when a gas-forming agent is used. Lime may include hydrated lime, quicklime or lime kiln dust. Lime kiln dust should contain free CaO of not less than 50 wt %. The lime content in the mixture should be up to about 10 wt % in the form of CaO. If the lime content is greater than 10 wt %, it will increase the water requirement and the shrinkage of the hardened concrete.

Fibers can be used to increase the strength of concrete, especially its flexural strength. Suitable ones include nylon fibers, polypropylene fibers, carbon fibers, cellulose fibers, and mixtures thereof. Additionally, fibers serve to stabilize the cellular structure in a fresh concrete mixture and to avoid the use of stabilizers. When a foaming agent is used, fibers also aid in the introduction of air into the concrete mixture.

The fiber content is preferably between about 0.02% to about 5%, by weight. If the fiber content is below 0.02%, the fresh mixture will not have a stable cellular structure. If the fiber content is higher than about 5%, it cannot be mixed uniformly and affects the formation of a uniform cellular structure.

The phenomena of concrete shrinkage during the drying process is complicated and widely acknowledged to be the function of several mechanisms. The principal factor is surface tension. The shrinkage reducing agent comprises a synergistic mixture of an alkyl ether oxyalkylene adduct having the Formula (I), RO(AO)ₙH wherein A is selected from C₂₋₄ alkylene groups, n has a value of 1 to 3 and R is a C₃₋₅ alkyl group in combination with lower oxyalkylene glycol compounds having the Formula (II), HO(AO)ₘH wherein A is selected from C₂₋₄ alkylene groups and m has a value of 1 to 3.

Polyoxyalkylene glycols are compounds known to be useful as set accelerators and shrinkage reduction additives for concrete. According to the present invention, lower oxyalkylene glycols used in combination with at least one alkyl ether oxyalkylene adduct maintain the void structure in cellular lightweight concrete mixtures and, further, provide cement composition products with good compressive strength.

The preferred glycols are diethylene glycol and dipropylene glycol, tripropylene glycol, and mixtures thereof with dipropylene glycol being most preferred. The optimum ratio of a compound of Formula I to a compound of Formula II is about 1:1, by weight.

The shrinkage reducing agent should be from about 0.01 wt % to about 3 wt % of the concrete mixture. Above that value, no further improvement is shown. An exemplary shrinkage reducing agent is commercially available from Grace Construction Products under the trademark ECLIPSE.

Superplasticizers are used to produce concrete of higher strength, obtain a specified strength at lower cementitious content, or increase the workability of a given mixture without an increase in water content. They also improve the properties of concrete containing aggregates that are harsh or poorly graded, or are useful in concrete intended to be used under harsh weather conditions. Superplasticizers are linear polymers containing sulfonic acid groups attached to the polymer backbone at regular intervals. Most of the commercial formulations belong to one of four families: sulfonated melamine-formaldehyde condensates (SMF), sulfonated naphthalene-formaldehyde condensates (SNF), modified lignosulfonates (MLS), and polycarboxylate (PC) derivatives. In this invention, a superplasticizer is used to reduce the water requirement of the concrete mixture in order to obtain a higher strength. The dosage is between 0.02% to 1%, by weight.

The other important component in a cellular concrete mixture is the gas-forming or foaming agent. Stable air bubbles are generated through chemical reaction between a gas-forming agent, such as aluminum, zinc or magnesium powders, or aluminum sulfate and an alkaline solution. Stable air bubbles are also formed through mechanical agitation of an aqueous solution of a foaming agent which comprises one of the alkaline salts of natural wood resins, alkaline salts of fatty acids, or alkaline salts of sulfonated organic compounds. In order to obtain the density and strength as specified in this invention, the quantity of the gas-forming or foaming agent should be between about 0.001 and about 1%, by weight.

The mixing process varies depending on whether a gas-forming agent or a foaming agent is used. When a gas-forming agent such as aluminum, zinc, or magnesium is used, cement, lime and aggregate are first blended, then mixed with water in a bowl mixer. After one to two minutes of mixing, fiber is added, followed by the gas-forming agent. It takes three to five minutes to yield a mixture with proper consistency. After mixing, the mixture is poured into a mold filled one-half to three-quarters full, depending on the proportions of the mixture for various finished products. The mixture expands to the full volume of the mold within 15 to 150 minutes, depending on its alkalinity and the particle size of the gas-forming agent. Release of H₂ gas from reaction between the gas-forming agent M and water is expressed as follows:

2M+2xH₂O→2M(OH)x+xH₂↑

Usually, an additive is required to stabilize the H₂ bubbles to form a uniform cellular structure in a slurry mixture without aggregate. Otherwise, the H₂ escapes and the cellular structure collapses. This phenomenon is more obvious in the presence of aggregate. According to the present invention, the use of fibers in a concentration of about 0.02 wt % to about 5 wt % stabilizes the H₂ gas bubbles within the slurry mixture without the use of a stabilizer and produces a very stable, uniform cellular structure. If the fiber content is less than about 0.2 wt %, H₂ escapes and structural collapse occurs. If the fiber content is higher than about 5 wt %, the fibers cannot disperse uniformly in the mixture during the mixing, which affects the distribution of H₂ gas bubbles.

About 4 to 6 hours after pouring, the molded mixtures is cured in a moist environment at room or elevated temperatures.

If a foaming agent is selected from alkaline salts of natural wood resins, or alkaline salts of fatty acids, or alkaline salts of sulfonated organic compounds, the agent should be first mixed with water, then with the blended dry materials. Air is introduced into the mixture through mechanical stirring. However, the use of a proper aggregate is critical for the introduction of air into the concrete mixture when a conventional concrete mixer is used. If the aggregate content is less than about 20 wt %, air cannot be effectively introduced therein. If the aggregate content is greater than about 55 wt % air also can not be introduced because of an insufficient amount of cement paste. Another important factor is the aggregate density. If the aggregate has a density greater than about 60 lb/ft³, it effects the stability of the cellular structure and tends to segregate. If the density of aggregate is lower than about 25 lb/ft³, the aggregate is too weak to produce high strength concrete for structural uses. Thus, the use of a proper aggregate amount is critical for the production of quality cellular lightweight concrete. The presence of fiber also helps the introduction of air and stabilization of the cellular structure.

The mixing time necessary to yield a mixture with the proper consistency and bubble structure can vary depending upon the percentage of each constituent. Usually about 3 to 5 minutes of mixing time is required to complete the foaming process. A superplasticizer can be used to increase the workability of the lightweight cellular concrete mixture at a lower water content.

After mixing, the mixture is poured into molds. About 4 to about 6 hours after molding, the mixtures can be cured in a moist environment at room or elevated temperatures.

The following examples describe the manner and process of a low shrinkage lightweight cellular concrete according to the present invention, and they set forth the best modes contemplated by the inventors of carrying out the invention, but they are not to be construed as limiting.

### EXAMPLE 1

Three batches of cellular lightweight concrete notated as Mix 1, Mix 2 and Mix 3 were prepared. The mixing proportion for each batch is summarized in Table 1. The course lightweight aggregate had a dry density of about 36.6 lb/ft³ and its gradation met ASTM C330 specifications. The fine aggregate had a dry density of about 48 lb/ft³ and its gradation met ASTM C331. Mix 1 did not contain any aggregate and was used as a baseline reference.

The mixing was carried out using a Kitchen Aid mixer. Dry powder materials were first uniformly blended, then mixed with water, followed by fiber, aggregate, if applicable, and aluminum powder. Ultimately, a flowable mixture was obtained. The total mixing time was approximately four to six minutes. The mixtures were each poured into one 3″×3″×11″ stainless mold and ten 2″×2″×2″ plastic cubes filled to about 50% to 80% of their volume. The mixtures expanded to completely fill these plastic molds within 45 minutes. The large specimen was used for drying shrinkage testing while the cubes were used as a measurement of moisture content, bulk density, and compressive strength. After setting for an additional two hours in a sample preparation room, the large sample and 3 cube samples with molds were cured in a steam chamber for 14 hours at 85° C.; the remained cubes were cured in a moist chamber at 23° C.

After curing, all of the samples were cooled to room temperature and demolded. The large sample was placed in a room with a relative humidity of 50±5% for measurement of dimensional change. Three cubes from each batch were first weighed, then placed in an oven at 65° C. for three days for measurement of moisture content, dry bulk density, and dry compressive strength.

Compared with the control batch Mix 1, the addition of aggregate slightly increased the density of the hardened lightweight concrete (Mix 2 and Mix 3). However, the introduction of aggregate did not affect the strength of concrete after steam curing at 85° C.

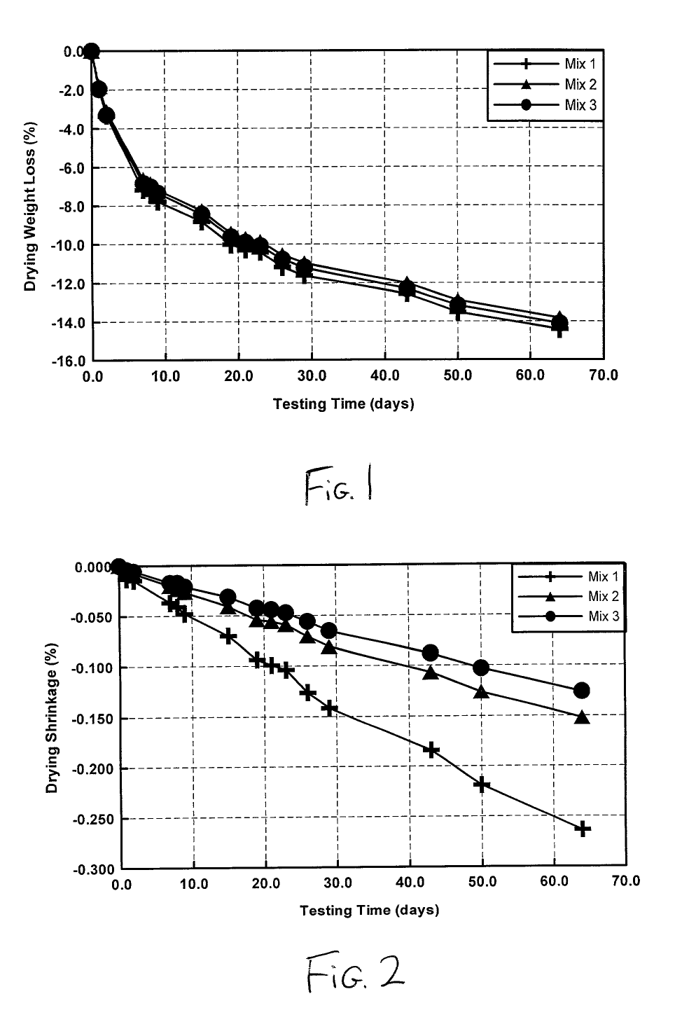

FIG. 1 shows the drying shrinkage of the three batches. Compared with the control batch (Mix 1), the addition of coarse lightweight aggregate (Mix 2) decreased the drying shrinkage by more than 40%. The combination of coarse aggregate and fine aggregate further decreased the shrinkage by an additional 20%. This means that the use of aggregate significantly decreases the drying shrinkage of cellular lightweight concrete and potentially eliminates cracking.

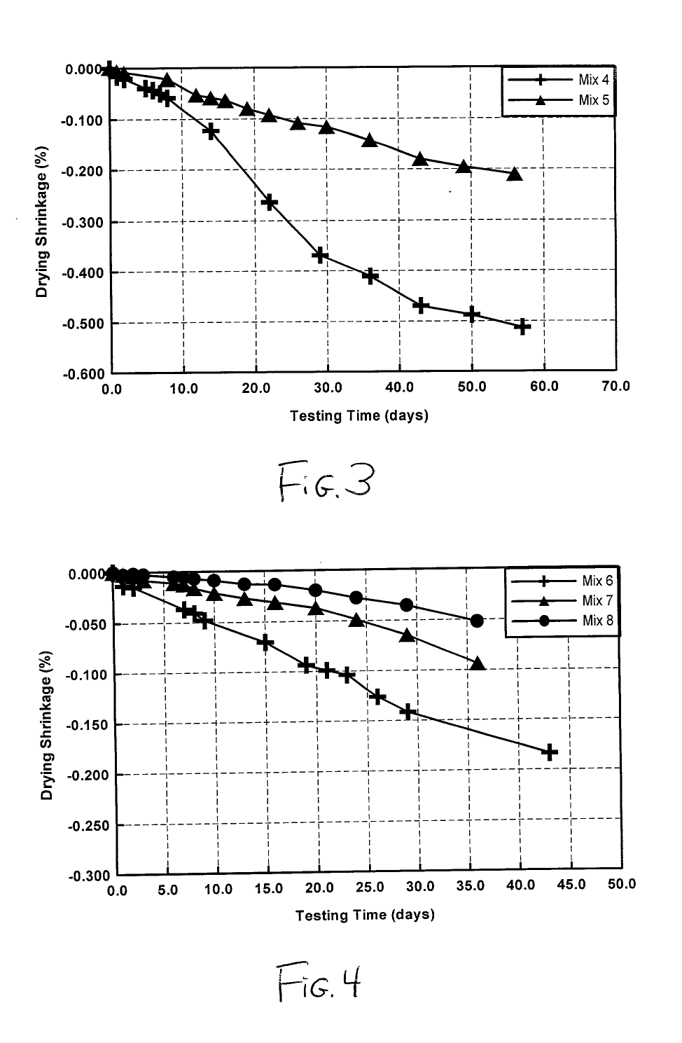

FIG. 2 shows the effect of the addition of aggregate on weight loss during the drying process. No significant difference was observed between the three batches. This means that the addition of aggregate does not affect the weight loss of cellular lightweight concrete during the drying process.

TABLE 1
Cellular Lightweight Concretes Containing Fly Ash

| | Mix 1 | Mix 2 | Mix 3 |
|---|---|---|---|
| MIXTURE COMPOSITION, | | | |
| wt % | | | |
| Type I Portland | 33.3 | 25.0 | 22.2 |
| Cement | | | |
| Fly Ash | 30.0 | 22.5 | 20.0 |
| Fine Lightweight | 0 | 0 | 11.1 |
| Aggregate | | | |
| Coarse Lightweight | 0 | 25 | 22.2 |
| Aggregate | | | |
| Quicklime | 2.0 | 1.5 | 1.3 |
| Gypsum | 1.3 | 1.0 | 0.9 |
| Aluminum Powder | 0.1 | 0.075 | 0.067 |
| Polypropylene fiber | 0.7 | 0.5 | 0.4 |
| Water | 33.3 | 25.0 | 22.2 |
| OVEN-DRY DENSITY, | 60.0 | 63.6 | 66.2 |
| lb/ft³(kg/m³) | (958) | (1016) | (1057) |
| COMPRESSIVE STRENGTH, | | | |
| psi (MPa) | | | |
| 14 hours of steam curing | 1426 | 1445 | 1471 |
| at 85° C. | (9.8) | (10.0) | (10.1) |
| Curing 3 days at room | 866 | 972 | 998 |
| temperature | (6.0) | (6.7) | (6.9) |
| Curing 28 days at room | 1641 | 1817 | 1770 |
| temperature | (11.3) | (12.5) | (12.2) |

### EXAMPLE 2

In this experiment, materials, preparation and testing of samples were the same as in Example 1 except ground glass was used as a cement replacement instead of fly ash. The composition of Mixes 4 and 5 and the testing results of these samples are summarized in Table 2.

The introduction of lightweight aggregate increased the density and strength of the concrete. The results in FIG. 2 indicate that the introduction of lightweight aggregate decreased shrinkage significantly.

TABLE 2
Cellular Lightweight Concretes Containing Lightweight Aggregate

| | Mix 4 | Mix 5 |
|---|---|---|
| MIXTURE COMPOSITION, wt % | | |
| Type I Portland Cement | 33.1 | 20.2 |
| Ground Glass | 33.1 | 21.5 |
| Coarse Lightweight | 0 | 35 |
| Aggregate | | |
| Quicklime | 0 | 1.3 |
| Aluminum Powder | 0.2 | 1.3 |
| Polypropylene fiber | 0.7 | 0.4 |
| Water | 33.1 | 21.5 |
| OVEN-DRY DENSITY, lb/ft³(kg/m³) | 44.6 | 55.3 |
| | (715) | (886) |
| COMPRESSIVE STRENGTH, psi (MPa) | | |
| 14 hours of steam curing at | 596 | 683 |
| 85° C. | (4.1) | (4.7) |
| Curing 7 days at room | 567 | 983 |
| temperature | (3.9) | (6.8) |
| Curing 28 days at room | 813 | 1121 |
| temperature | (5.6) | (7.7) |

### EXAMPLE 3

Table 3 shows the effect of shrinkage reducing agent and aggregate on selected properties of cellular lightweight concrete Mixes 6 to 8. The shrinkage reducing agent was a mixture of an oxyalkylene adduct and an oxyalkylene glycol with a weight ratio of about 1:1.

By comparing Mixes 6 and 7, it was determined that the use of a shrinkage reducing agent does not have a significant effect on the density and strength of concrete; however, it significantly decreased the drying shrinkage. The combined use of a shrinkage reducing agent and a lightweight aggregate further decreased shrinkage.

TABLE 3
Cellular Lightweight Concretes Containing Ground
Glass, Shrinkage Reducing Agent and Aggregate

| | Mix 6 | Mix 7 | Mix 8 |
|---|---|---|---|
| MIXTURE COMPOSITION, | | | |
| wt % | | | |
| Type I Portland | 31.1 | 30.7 | 20.3 |
| Cement | | | |
| Ground Glass | 33.1 | 32.7 | 21.6 |
| Coarse Lightweight | 0 | 0 | 34.6 |
| Aggregate | | | |
| Quicklime | 2.0 | 2.0 | 1.3 |
| Aluminum Powder | 0.05 | 0.05 | 0.04 |
| Polypropylene fiber | 0.7 | 0.7 | 0.4 |
| Shrinkage Reducing | 0 | 1.3 | 1.0 |
| Agent | | | |
| Water | 33.1 | 32.7 | 21.6 |
| OVEN-DRY DENSITY, | 54.6 | 55.8 | 59.2 |
| lb/ft³(kg/m³) | (875) | (894) | (948) |
| COMPRESSIVE STRENGTH, | | | |
| psi (MPa) | | | |
| 14 hours of steam curing | 1145 | 1077 | 930 |
| at 85° C. | (7.9) | (7.4) | (948) |
| 3 days of room | 1041 | 1314 | 930 |
| temperature curing | (7.2) | (9.1) | (6.4) |
| 28 days of room | 1377 | 1641 | 1623 |
| temperature curing | (9.3) | (11.3) | (11.2) |

### EXAMPLE 4

Table 4 shows the effect of a shrinkage reducing agent and a superplasticizer in the production of a cellular lightweight concrete. The use of a superplasticizer reduces the water requirement for a given flowability of lightweight concrete slurry. It slightly increased the density of the hardened concrete, but more importantly, it significantly decreased shrinkage.

TABLE 4
Cellular Lightweight Concrete Containing Ground Glasses,
Shrinkage Reducing Agent and Superplasticizer

| | Mix 9 |
|---|---|
| MIXTURE COMPOSITION, wt % | |
| Type I Portland Cement | 21.5 |
| Ground Glass | 22.8 |
| Coarse Lightweight Aggregate | 36.5 |
| Quicklime | 1.5 |
| Aluminum Powder | 0.05 |
| Polypropylene Fiber | 0.5 |
| Shrinkage Reducing Agent | 1.0 |
| Superplasticizer (PC) | 0.5 |
| Water | 16.0 |
| OVEN-DRY DENSITY, lb/ft₃(kg/m₃) | 67.8 |
| | (1086) |
| COMPRESSIVE STRENGTH, psi (MPa) | |
| 14 hours of steam curing at 85° C. | 1359 |
| | (9.4) |
| 3 days of room temperature curing | 1817 |
| | (12.5) |
| 28 days of room temperature curing | 2070 |
| | (14.3) |

### EXAMPLE 5

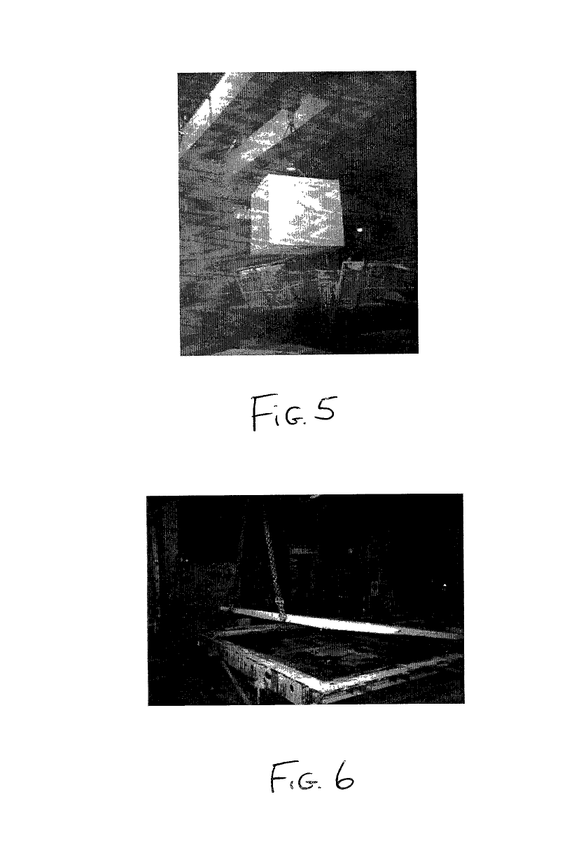

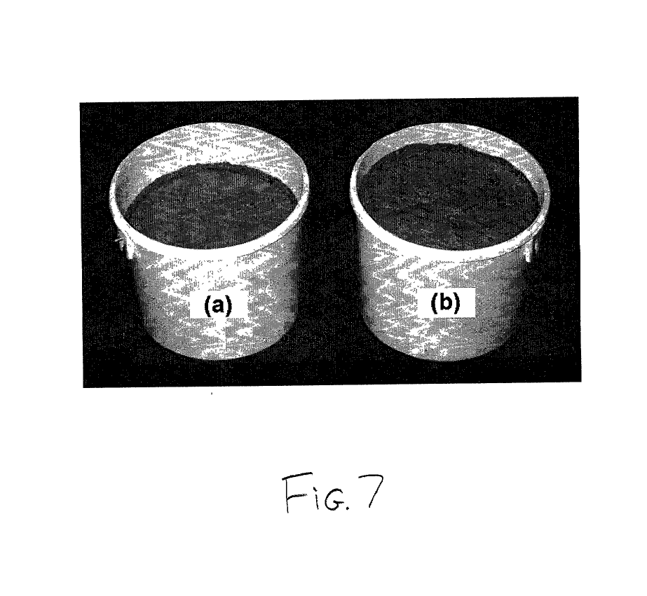

Table 5 shows the composition of high strength cellular lightweight concrete mixtures designated Mixes 10 and 11. These batches used both course and fine lightweight aggregate, a shrinkage reducing agent and a superplasticizer with a relatively low water content. They had a density slightly higher than half that of regular concrete, but with a similar strength. Compared with Mix 10, Mix 11 had a higher aggregate content while exhibiting significantly higher strength after stream curing. It is well know that the higher the aggregate content, the lower the water content and the lower the shrinkage of a concrete. FIG. 4 shows the lifting of a 4′×4′×6′ concrete tank with a thickness of 4″ made with Mix 10 after approximately 6 hours of steam curing at about 65° C. This picture indicates that the cellular lightweight concrete of the present invention can be used to manufacture products typically made from conventional concrete.

TABLE 5
High Strength Cellular Lightweight Concretes Containing
Lightweight Aggregate and Blast Furnace Slag

| | Mix 10 | Mix 11 |
|---|---|---|
| COMPOSITION, wt % | | |
| Type I Portland Cement | 25.1 | 20.6 |
| Ground Blast Furnace | 16.8 | 13.8 |
| Slag | | |
| Coarse Lightweight | 25.1 | 31.0 |
| Aggregate | | |
| Fine Lightweight | 16.8 | 20.6 |
| Aggregate | | |
| Foaming | 0.005 | 0.005 |
| Superplasticizer (PC) | 0.10 | 0.10 |
| Polypropylene Fiber | 0.21 | 0.18 |
| Shrinkage Reducing | 1.0 | 1.0 |
| Agent | | |
| Water | 15.9 | 13.8 |
| OVEN-DRY DENSITY, | 178.5 | 183.0 |
| lb/ft³(kg/m³) | (1258) | (1329) |
| COMPRESSIVE STRENGTH, psi (MPa) | | |
| 14 hours of steam curing at | 3672 | 5080 |
| 85° C. | (25.3) | (35.5) |
| Curing 28 days at room | 5336 | |
| temperature | (36.8) | |

### EXAMPLE 6

In this experiment, all the materials used are the same as in Example 1, however, the proportions of the various constituents are different in order to show how the fiber content effects air entrainment and cement stability. The weight percentages for the two mixtures in this example are the same except for the fiber content. The cements contained: 34.4% Type I Portland cement, 20.7% fine lightweight aggregate, 31.0% coarse lightweight aggregate, 13.8% water and 0.1% foaming agent. Various cements were produced have the following respective polypropylene fiber contents: 0%, 0.085%, 0.17%, 0.34% and 0.51%. After about one minute of mixing all of the materials except for the foaming agent, the density of the mixture (D₀) was measured. Then, the forming agent was added and the mixture was mixed for about nine minutes. The density was measured again and notated as D₁. The entrained air content was calculated based on the density of the concrete before and after the addition of the foaming agent, as follows:

Entrained Air Content=(D₀−D₁)/D₀×100%

Air stability evaluation testing was performed on the cement mixtures according to the following procedure. After the second density measurement, the mixtures were left in the mixing bowl for about 15 minutes, then mixed for about 30 seconds, and then a third density measurement (D₃) was conducted. The air loss during the stability testing was calculated using the following equation:

Air Loss=(D₂−D₁)/D₀×100%

Table 6 shows the effect of fiber on the entrained air content and air loss during the air stability testing. The entrained air content increased as the fiber portion increased from 0% to 0.34%. The entrained air content of the mixture having 0.34% fiber was 21.1%, while the entrained air content without any fiber was 10.2%. The former is more than twice that of the latter. As the fiber portion increased from 0.34% to 0.51%, the entrained air content started to decrease. This means that about 0.34% fiber is the optimum content for the purpose of air entrainment for this mixture.

TABLE 6
Effect of Fiber Portion on Air Content

| | Entrained Air | | Air Loss After |
|---|---|---|---|
| Fiber | Content | Relative | Stability Testing |
| Portion | (% of Concrete | Entrained Air | (% of Total |
| (wt %) | Mixture) | Content (%) | Entrained Air) |
| 0 | 10.2 | 100 | 20.59 |
| 0.085 | 15 | 147 | 9.33 |
| 0.17 | 18.6 | 182 | 6.45 |
| 0.34 | 21.1 | 206 | 3.79 |
| 0.51 | 20.1 | 197 | 5.47 |

Air losses for the mixtures of this example are listed in the last column of Table 6. There, it can be seen that the introduction of 0.085% fiber decreased the air loss from 20.58% to 9.33%. The increase in fiber content further decreased the air loss until 0.34% fiber, which showed an air loss of 3.79%. As the fiber content increased from 0.34% to 0.51%, the air loss increased from 3.79% to 5.47%. Thus, the mixture with about 0.34% fiber is also the best from the aspect of air void stability.

### EXAMPLE 7

This example demonstrates the effect of fiber on the aeration process and the stability of cellular structure of aerated mixtures in the absence of a bubble stabilizer. Aluminum powder was used as a gas-forming agent. Two similar mixing proportions were designed. The mixtures contained, by wt. %: 56.6 Portland cement, 9.9% fly ash, 33.3% water and 0.2% aluminum powder. One of the mixtures contained 0.67% polypropylene fiber while the other did not contain any fiber. These materials were mixed in a similar manner as described above in Example 6, then poured into two 2-gallon containers for aeration testing.

During aeration testing, it was noticed that a lot of gas bubbles escaped from the surface of the mixture without fiber. Later on, the cellular structure collapsed. FIG. 7 is a picture of the two buckets containing the respective mixtures at the end of aeration. Many tiny holes resulting from escaping gas can be seen on the surface of the mixture designated (a).

During the aeration process, very little gas escaped from the mixture containing fibers, as shown in the mixture designated (b). The surface of this mixture looks very smooth. Compared with bucket (a), it can be seen that the mixture containing fibers (b) had more volume than the mixture without. Thus, the use of fiber is very helpful in producing a stable aerated cellular structure.

The foregoing has described the invention and certain embodiments thereof. It is to be understood that the invention is not necessarily limited to the precise embodiments described therein but variously practiced with the scope of the following claims.

What is claimed is:

1. A cellular structural lightweight concrete comprising, by weight:
a) about 30% to about 45% cementing material;
b) about 20% to about 55% aggregate;
c) about 0.02% to 5% fiber;
d) a lime containing material;
e) a shrinkage reducing agent;
f) about 0.001% to 1.0% of a gas-forming agent or a foaming agent; and,
g) about 12% to 30% water.

2. The concrete of claim 1 having a dry density from about 45 lb/ft³ to about 90 lb/ft³.

3. The concrete of claim 1 wherein a compressive strength of the concrete is from about 1,000 psi to about 6,000 psi after 28 days of curing at room temperature.

4. The concrete of claim 1 wherein the cementing material includes Portland cement.

5. The concrete of claim 1 wherein the cementing material has either cementitious or pozzolanic properties and is selected from the group consisting of coal fly ash, natural pozzolan, ground blast furnace slag, ground steel slag, silica fume, and mixtures thereof.

6. The concrete of claim 1 wherein the aggregate is selected from the group consisting of volcanic ash, pumice, scoria, tuff, and expanded, palletized or sintered blast furnace slag, clay, diatomite, fly ash, shale, perlite, vermiculite, slate, and mixtures thereof.

7. The concrete of claim 1 wherein the aggregate includes both fine and coarse aggregate.

8. The concrete of claim 1 wherein the aggregate has a density between 25 lb/ft³ to 60 lb/ft³.

9. The concrete of claim 1 wherein the lime containing material is selected from the group consisting of quick lime, hydrated lime, and any material containing at least 50% free CaO.

10. The concrete of claim 1 wherein the shrinkage reducing agent is selected from the group consisting of at least one alkyl ether oxyalkylene adduct represented by the formula: RO (AO)ₙH, wherein A is a C₂₋₄ alkylene radical, O is an oxygen atom, R is a tertiary alkyl group and n is an integer from 1 to 3, and an oxyalkylene glycol represented by the formula: HO(AO)ₘH, wherein A is a C₂₋₄ alkylene radical, O is an oxygen atom, and m is an integer of 1 to 3.

11. The concrete of claim 1 wherein the shrinkage reducing agent comprises an alkyl ether oxyalkylene adduct and a tertiary alkyl group in a weight ratio of about 1:1.

12. The concrete of claim 1 wherein the shrinkage reducing agent is present in a concentration about 0.01% to about 3%, by weight.

13. The concrete of claim 1 wherein the gas-forming agent is selected from the group consisting of aluminum powder, zinc powder, magnesium powder, aluminum sulfate, and mixtures thereof.

14. The concrete of claim 1 wherein the foaming agent is an alkaline salt selected from the group consisting of natural wood resins, fatty acids, sulfonated organic compounds, and mixtures thereof.

15. The concrete of claim 1 further including fibers selected from the group consisting of nylon fibers, polypropylene fibers, carbon fibers, cellulose fibers, and mixtures thereof.

16. The concrete of claim 15 wherein the fiber is present in a concentration of about 0.02% to about 5%, by weight.

17. The concrete of claim 1 further comprising a superplasticizer as a linear polymer containing sulfonic acid groups attached to the polymer backbone at regular intervals.

18. The concrete of claim 17 wherein the superplastizer is selected from the group consisting of sulfonated melamine-formaldehyde condensates (SMF), sulfonated naphthalene-formaldehyde condensates (SNF), modified lignosulfonates (MLS), polycarboxylate derivatives, and mixtures thereof.

19. The concrete of claim 17 wherein the superplastizer is present in a concentration of about 0.02% to about 1%, by weight.

20. A method for making cellular concrete product using a cellular concrete mixture, comprising the steps of:
a) mixing, by weight, about 30% to about 45% cementing material with about 20% to about 55% aggregate, a lime containing material, about 0.02% to 5% fiber, about 0.01% to about 3% of a shrinkage reducing agent, about 0.001% to 1.0% of a gas-forming agent or foaming agent, and about 12% to 30% water to provide a concrete mixture;
b) pouring the concrete mixture to partially fill the total volume of a form;
c) allowing the poured concrete mixture to expand to the total volume of the form;
d) allowing the expanded concrete to set;
e) curing the set concrete in a moist environment; and
f) utilizing the cured concrete.

21. The method of claim 20 including providing the concrete having a dry density from about 45 lb/ft³ to about 90 lb/ft³.

22. The method of claim 20 including providing the concrete having a compressive strength of from about 1,000 psi to about 6,000 psi after about 28 days of curing at room temperature.

23. The method of claim 20 including providing the cement as Portland cement.

24. The method of claim 20 including providing the cementing material having either cementitious or pozzolanic properties and being selected from the group consisting of coal fly ash, natural pozzolan, ground blast furnace slag, ground steel slag, silica fume, and mixture thereof.

25. The method of claim 20 including selecting the aggregate from the group consisting of pumice, scoria, tuff, and expanded blast furnace slag, palletized blast furnace slag, sintered blast furnace slag, clay, diatomite, fly ash, shale, perlite, vermiculate, slate, and mixtures thereof.

26. The method of claim 20 including providing the lightweight aggregate as either fine or coarse aggregate.

27. The method of claim 20 including providing the aggregate having a density of from about 25 lb/ft³ to about 60 lb/ft³.

28. The method of claim 20 including selecting the lime containing material from the group consisting of quick lime, hydrated lime and any material containing at least 50% free CaO.

29. The method of claim 20 including selecting the shrinkage reducing agent from the group consisting of at least one alkyl ether oxyalkylene adduct represented by the formula: RO(AO)ₙH, wherein A is a C₂₋₄ alkylene radical, O is an oxygen atom, R is a tertiary alkyl group and n is an integer from 1 to 3, and an oxyalkylene glycol represented by the formula: HO(AO)ₘH, wherein A is a C₂₋₄ alkylene radical, O is an oxygen atom, and m is an integer of 1 to 3.

30. The method of claim 20 including providing the shrinkage reducing agent in a concentration from about 0.01% to about 3%, by weight.

31. The method of claim 20 including selecting the gas forming agent from the group consisting of aluminum powder, zinc powder, magnesium powder, aluminum sulfate, and mixtures thereof.

32. The method of claim 20 including providing the foaming agent as an alkali salt selected from the group consisting of natural wood resins, fatty acids, sulfonated organic compounds, and mixtures thereof.

33. The method of claim 20 further including providing the concrete comprising fibers selected from the group consisting of nylon fibers, polypropylene fibers, carbon fibers, cellulose fibers, and mixtures thereof.

34. The method of claim 33 including providing the fiber in a concentration of about 0.02% to about 5%, by weight.

35. The method of claim 20 further including mixing a superplasticizer of a linear polymer containing sulfonic acid groups attached to the polymer backbone at regular intervals.

36. The method of claim 35 including selecting the superplastizer from the group consisting of sulfonated melamine-formaldehyde condensates (SMF), sulfonated naphthalene-formaldehyde condensates (SNF), modified lignosulfonates (MLS), polycarboxylate derivatives, and mixtures thereof into the concrete mixture

37. The method of claim 35 including providing the superplastizer in a concentration of about 0.02% to about 1%, by weight.
